(19) United States
(12) Patent Application Publication
(10) Pub. No.: US 2017/0228623 A1
(43) Pub. Date: Aug. 10, 2017

(54) PRINT CONTROL DEVICE, PRINTING SYSTEM, NON-TRANSITORY COMPUTER READABLE MEDIUM, AND PRINT CONTROL METHOD

(71) Applicant: FUJI XEROX CO., LTD., Tokyo (JP)

(72) Inventors: Mitsuoki ONO, Yokohama-shi (JP); Miho ISHIZUKA, Yokohama-shi (JP)

(73) Assignee: FUJI XEROX CO., LTD., Tokyo (JP)

(21) Appl. No.: 15/244,473

(22) Filed: Aug. 23, 2016

(30) Foreign Application Priority Data
Feb. 9, 2016 (JP) 2016-022610

(51) Int. Cl. G06K 15/00; G06F 3/12

(52) U.S. Cl. CPC G06K 15/408; G06F 3/121; G06F 3/1234; G06F 3/1288

(57) ABSTRACT

A print control device is provided with a storage unit that stores print data which is being processed in another print control device that controls a printing device so as to perform print processing based on received print data, an acquisition unit that acquires second printed-page information from the printing device, and a controller. When an error occurs in the other print control device, the controller receives first printed-page information from the other print control device, determines a restart page from the first printed-page information received from the other print control device and the second printed-page information acquired by the acquisition unit, and controls the printing device on behalf of the other print control device so as to restart the print processing based on the print data from the restart page.

### CROSS-REFERENCE TO RELATED APPLICATIONS

This application is based on and claims priority under 35 USC 119 from Japanese Patent Application No. 2016-022610 filed Feb. 9, 2016.

### BACKGROUND

### Technical Field

The present invention relates to a print control device, a printing system, a non-transitory computer readable medium, and print control method.

### SUMMARY

According to an aspect of the invention, a print control device includes a storage unit that stores print data which is being processed in another print control device that controls a printing device so as to perform print processing based on received print data, an acquisition unit that acquires second printed-page information from the printing device, and a controller. When an error occurs in the other print control device, the controller receives first printed-page information from the other print control device, determines a restart page from the first printed-page information received from the other print control device and the second printed-page information acquired by the acquisition unit, and controls the printing device on behalf of the other print control device so as to restart the print processing based on the print data from the restart page.

### BRIEF DESCRIPTION OF THE DRAWINGS

Exemplary embodiments of the present invention will be described in detail based on the following figures, wherein:

FIG. 1 illustrates a system configuration of a printing system in an exemplary embodiment in the present invention;

FIG. 2 illustrates a case where, a failure occurs in a print server in an active system during performing print processing by an output device in the printing system in the exemplary embodiment, and the print processing is restarted by switching the print server to a print server in a standby system;

FIG. 3 illustrates a hardware configuration of print servers in the exemplary embodiment;

FIG. 4 is a block diagram illustrating a functional configuration of print servers in the present exemplary embodiment;

FIG. 5 illustrates an operation of the print server when starting a print job;

FIG. 6 is a flowchart illustrating an operation of a job information acquisition unit;

FIG. 7 is a flowchart illustrating an operation of an output management unit when restarting the print processing;

FIG. 8 illustrates a specific example of generating print job information for the output management unit to perform reprinting; and

FIG. 9 illustrates a display screen example of presenting a reprinting start page to a user when the reprinting is started.

### DETAILED DESCRIPTION

Next, an exemplary embodiment in the present invention will be described in detail with reference to the drawings.

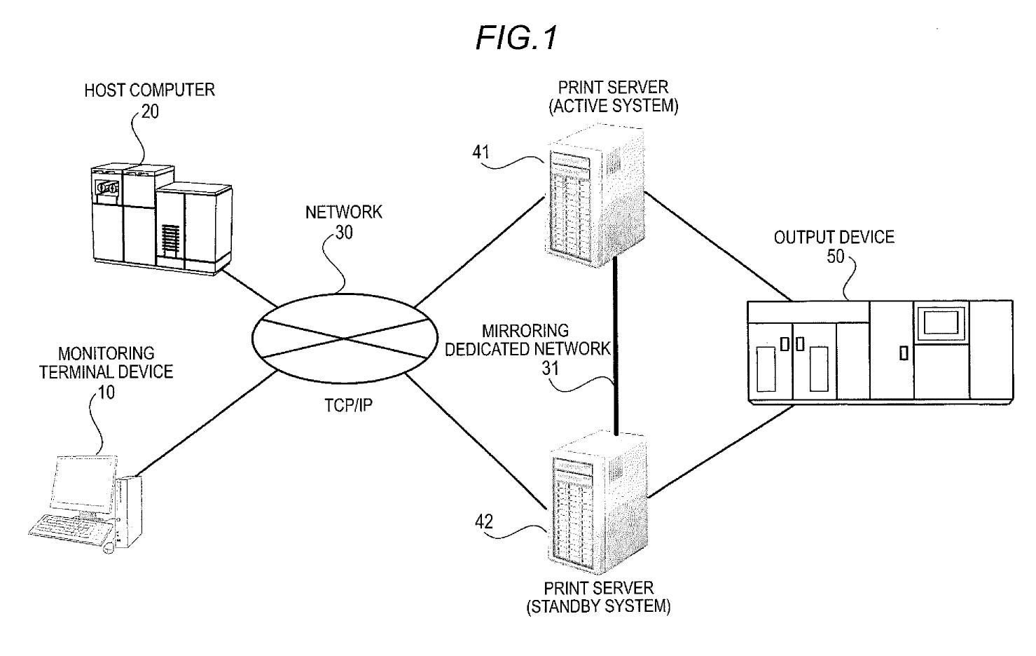

FIG. 1 is a system diagram illustrating a system configuration of a printing system in an exemplary embodiment in the present invention.

As illustrated in FIG. 1, the printing system in the exemplary embodiment of the present invention is configured to include a monitoring terminal device 10, a host computer 20, two print servers (print control devices) 41 and 42, and an output device (printing device) 50.

In addition, the monitoring terminal device 10, the host computer 20, and the two print servers 41 and 42 are connected to each other by a network 30 having a Transmission Control Protocol/Internet protocol (TCP/IP protocol).

The print server 41 in the active system is a print server that controls the printing device 50 so as to perform print processing based on a print job received from the host computer 20. In addition, the print server 42 in the standby system is a print server that controls the output device 50 to restart the print processing on behalf of the print server 41 in the active system in a case where a failure occurs in the print server 41 in the active system.

In the configuration of the printing system in the present exemplary embodiment, two print servers of the print server 41 in the active system and the print server 42 in the standby system are provided, and even in a case where the failure occurs in the print server 41 in the active system, and thus, the print processing is stopped, the print processing can be restarted by the print server 42 in the standby system.

The host computer 20 performs distribution of the print jobs and monitoring of the state of the print servers 41 and 42. In addition, the monitoring terminal device 10 also performs monitoring of the state of the print servers 41 and 42.

In addition, a print control program for converting print data in the print job (printing instruction) distributed from the host computer 20 to raster image data or the like and outputting the raster image data to the output device 50, is installed on each of the print servers 41 and 42.

The print server 41 in the active system and the print server 42 in the standby system are connected to each other by a mirroring dedicated network 31. Then, the mirroring is performed by the data in a hard disk drive (HDD) in the print server 41 in the active system being transferred to the HDD in the print server 42 in the standby system via the mirroring dedicated network 31.

In a case of performing the print processing of a certain print job, the print job of which the print processing is intended to be performed is distributed to the print server 41 in the active system from the host computer 20. Then, the print job received by the print server 41 in the active system is stored in the print server 41 and is also stored in the print server 42 in the standby system via the mirroring dedicated network 31. Therefore, even in a case where the print server that performs the print processing is switched to the print server 42 in the standby system from the print server 41 in the active system, it is not necessary for the host computer 20 to re-distribute the print job to the print server 42 in the standby system.

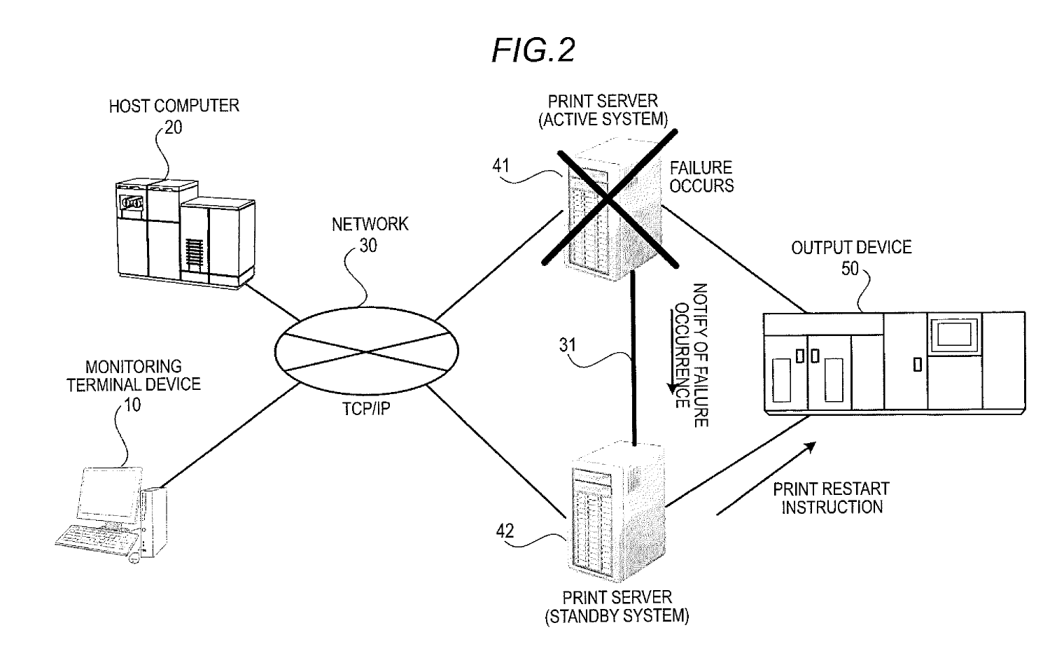

An aspect of a case is illustrated in FIG. 2, in which a failure occurs in a print server 41 in the active system during performing print processing by the output device 50 in the printing system in the present exemplary embodiment having such a configuration, and the print processing is restarted by switching the print server to the print server 42 in the standby system.

In a case where a failure occurs in the print server 41 in the active system during performing print processing of a certain print job, the print server 42 in the standby system is notified of occurrence of failure from the print server 41 in the active system, the print control program of the print server 42 in the standby system is started to operate.

Then, the program started to operate in the print server 42 in the standby system receives printed-page information indicating up to which page the print processing has been finished until the failure occurs from the print server 41 in the active system, and also acquires the printed-page information from the output device 50.

Then, the print server 42 in the standby system compares the information, and in a case where the print processing for all the pages has not been finished yet, instructs the output device 50 to restart the print processing from a page next to a page up to which the print processing has been normally finished,

A specific method will be described later by which the print server 42 in the standby system specifies a page from which the printing is restarted, based on the printed-page information acquired from the print server 41 in the active system and the printed-page information acquired from the output device 50.

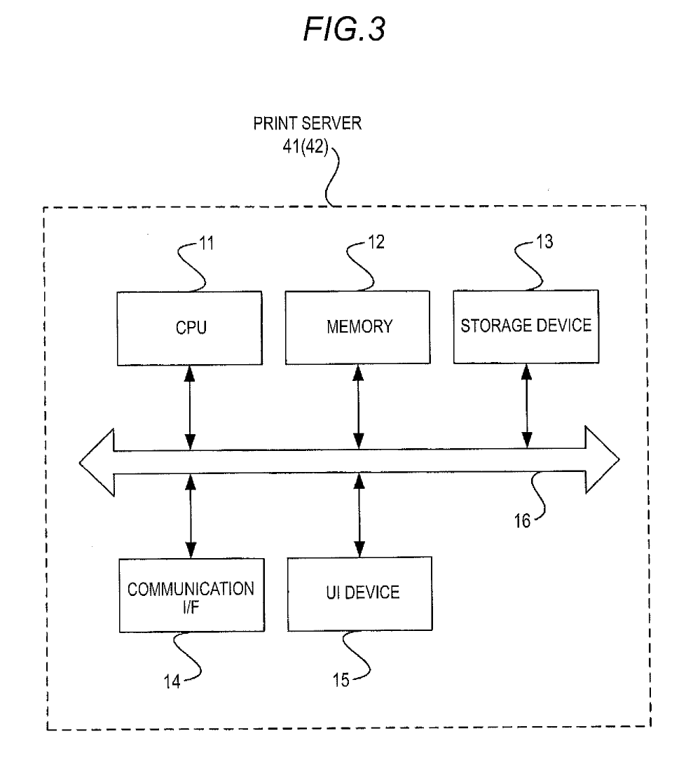

Next, a hardware configuration of these print servers 41 and 42 will be described with reference to FIG. 3. The configuration of the print server 41 is described here, and since the print server 42 has a similar configuration, the description thereof will be omitted.

As illustrated in FIG. 3, the print server 41 (42) includes a CPU 11, a memory 12, a storage device 13 such as a hard disk drive (HDD), a communication interface (I/F) 14 that performs transmission and reception of the data to and from an external devices or the like via the networks 30 and 31, and a user interface (UI) device 15 including a touch panel, a liquid crystal display, or a keyboard. The configuration elements are connected to each other via a control bus 16.

The CPU 11 performs predetermined processing based on the print control program stored in the memory 12 or in the storage device 13 and controls the operation of the print server 41 (42). In the description in the present exemplary embodiment, the CPU 11 reads out and executes the print control program stored in the memory 12 or in the storage device 13. However, the program can also be stored in a storage medium such as a CD-ROM and can be provided to the CPU 11.

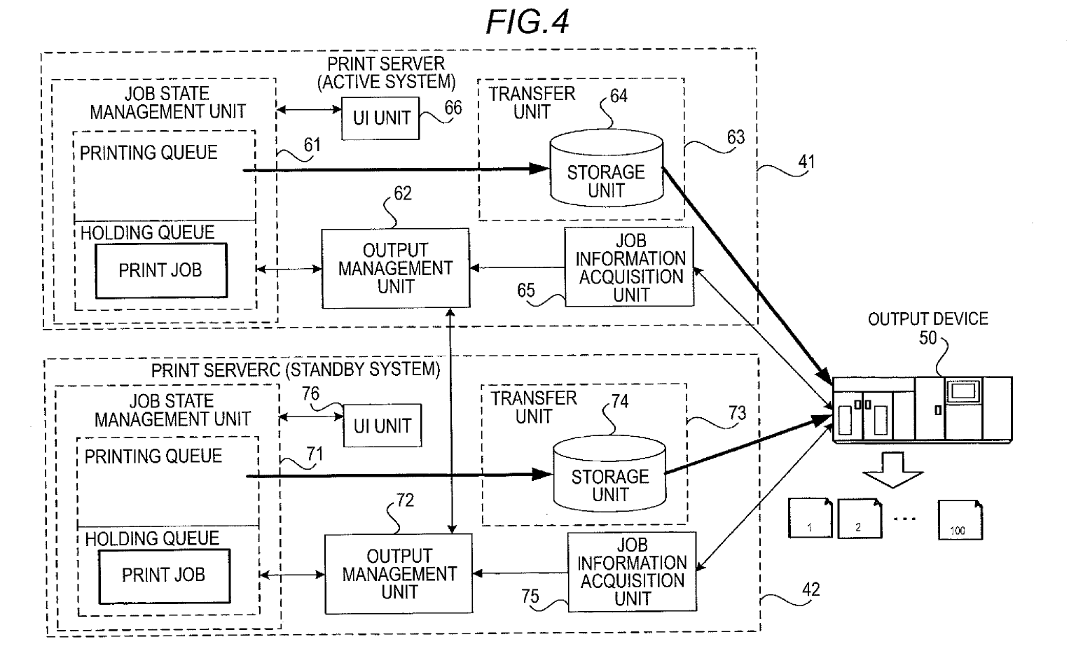

FIG. 4 is a block diagram illustrating a functional configuration of the print servers 41 and 42 realized by executing the control program described above.

As illustrated in FIG. 4, the print server 41 in the present exemplary embodiment includes a job state management unit 61, an output management unit 62, a transfer unit 63 having the storage unit 64, a job information acquisition unit 65, and a UI unit 66.

The job state management unit 61 manages a state of the received print job, and stores the print job which is waiting until the print processing is performed in a holding queue, and in a case where the actual print processing is needed to be performed, then, moves the print job stored in the holding queue to a printing queue to perform the print processing. In addition, in order to manage the print job that is being printed, the job state management unit 61 creates a document name (name information) for the print job that is being printed, and then, transfers the print job to a transfer unit 63 together with the document name information.

In addition, the job state management unit 61 assigns a job ID (identifier) for internal management in the print job that is being printed in addition to the document name, and notifies the output management unit 62 of the results.

Here, the document name may be unique in the system, or information in which a sequential number and a print start time are added to the job name may be used.

The output management unit 62 manages the information such as the document name and the job ID of the print job that is being printed received from the job state management unit 61 until the print processing is finished. In addition, in a case where a print start notification is received from the job state management unit 61, the output management unit 62 holds the job information of the print job. In addition, in a case where a print finish notification is received from the job state management unit 61, the output management unit 62 discards the held job information.

The transfer unit 63 transfers the print job moved to the printing queue in the job state management unit 61 to the output device 50 after spooling once in the storage unit 64.

The job information acquisition unit 65 periodically acquires the printed-page information of the print job and the document name information from the output device 50 as the job information until the print processing based on the print job is finished in the output device 50. Then, the job information acquisition unit 65 notifies the output management unit 62 of the acquired job information.

The UI unit 66 is a user interface for performing a display to the user via the display or receiving an input such as the page from which the printing is restarted.

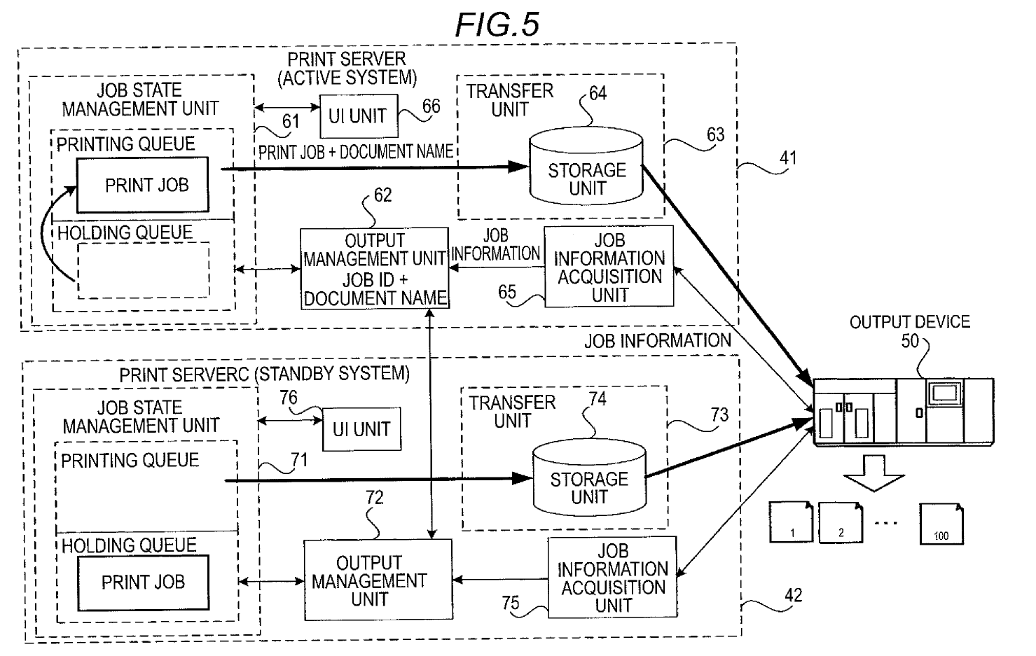

In a case of actually starting the print processing, as illustrated in FIG. 5, in the job state management unit 61, the print job in the holding queue is moved to the printing queue. Then, the print processing of the print job starts to be performed, and the print job is transmitted to the storage unit 64 in the transfer unit 63 together with the document name information for performing the printing. Then, the print job stored in the storage unit 64 is transferred to the output device 50, and then, the print processing is performed. Then, during the performing of the print processing in the output device 50, the job information acquisition unit 65 acquires the job information from the output device 50 and notifies the output management unit 62 of the job information. The output management unit 62 checks up to which page the print processing is finished in the print job that is being printed using the notified job information.

In addition, the configuration of print server 42 in the standby system is similar to that of the print server 41 in the active system, and includes a job state management unit 71, an output management unit 72, a transfer unit 73 having a storage unit 74, a job information acquisition unit 75, and a UI unit 76 as illustrated in FIG. 4, and performs the operation similar to that in the print server 41 when performing the print processing.

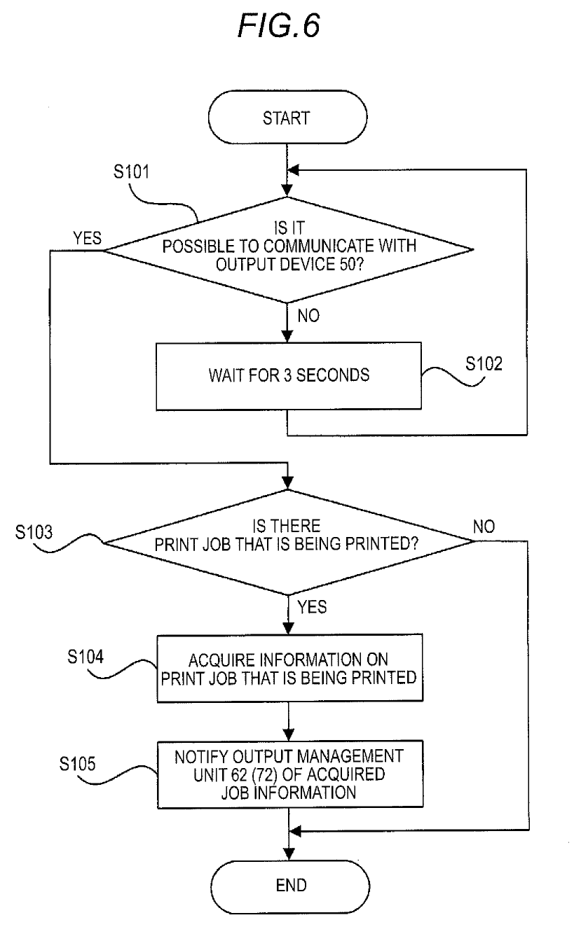

Next, the operation of the job information acquisition unit 65 (75) described above will be described with reference to a flowchart in FIG. 6.

In a case where it is possible to communicate with the output device 50 (Yes in STEP S101), the job information acquisition unit 65 (75) perform communication with the output device 50 and determines whether there is a print job that is being printed (STEP S103).

In a case where it is not possible to communicate with the output device 50 (No in STEP S101), the job information acquisition unit 65 (75) waits for, for example, three seconds (STEP S102), and determines again whether it is possible to communicate with the output device 50 or not (STEP S101),

Then, in a case where it is determined that there is a print job that is being printed in the output device 50 in STEP S103, the job information acquisition unit 65 (75) acquires the printed-page information from the output device 50 as the job information, which is information on the document name or the page of the print job for which the print processing is normally finished (STEP S104).

Then, the job information acquisition unit 65 (75) notifies the output management unit 62 (72) of the acquired job information (STEP S105).

As described above, the job information acquisition unit 65 (75) repeatedly performs the processing items illustrated in flowchart in FIG. 6 while the output device 50 performs the print processing and periodically acquires the job information, and then, continues to notify the output management unit 62 (72).

Next, the operation of the print server 42 in the standby system in a case where a failure occurs in the print server 41 in the active system will be described.

The print server 42 in the standby system has a function of receiving a copy of the print job that is being printed from the print server 41 in the active system via a communication line. Therefore, in the print server 42 in the standby system, the print job being processed in the print server 41 in the active system which is another print control device is stored in the holding queue in the job state management unit 71 using the mirroring processing described above.

Then, if a failure occurs in the print server 41 in the active system, the print server 42 in the standby system is notified of the occurrence of failure by the print server 41 in the active system, and the print control program is started in the print server 42 in the standby system.

In a case where the failure occurs in the print server 41 in the active system and the occurrence of failure is notified, the output management unit 72 that controls the print processing receives the printed-page information from the output management unit 62 of the print server 41 in the active system together with the notification.

In addition, the job information acquisition unit 75 acquires the job name information of the print job and the printed-page information from the output device 50 in which the print processing is stopped as information on the job that is being printed, and notifies the output management unit 72 of the acquired information items.

Then, when the notification of the acquisition of the job information is received from the job information acquisition unit 75, the output management unit 72 in the print server 42 in the standby system generates a reprint job for performing the output determination processing and starting the reprinting. At this time, the output management unit 72 determines a restart page from which the print processing is restarted using the printed-page information acquired by the job information acquisition unit 75 and the printed-page information received from the print server 41 in the active system.

Specifically, the output management unit 72 determines a page next to a page indicated by the printed-page information acquired by the job information acquisition unit 75, as the restart page, after the failure occurred in the print server 41 in the active system.

In a case where the printed-page information acquired by the job information acquisition unit 75 and the printed-page information received from the print server 41 in the active system are different from each other, the output management unit 72 may display on the UI unit 76 that it is necessary to check pages between the pages indicated by the two pieces of printed-page information.

At this time, the job information acquisition unit 75 acquires the document name (name information) of the print job that is being printed from the output device 50 together with the printed-page information, and notifies the output management unit 72 of the information items. Therefore, the output management unit 72 specifies the print job to be reprinted from the print job stored in the holding queue in the job state management unit 71 using the document name information acquired by the job information acquisition unit 75.

Then, on behalf of the print server 41 in the active system, the output management unit 72 controls the printing device 50, and controls the printing device 50 such that the performing of the print processing is restarted from the determined restart page based on the print job.

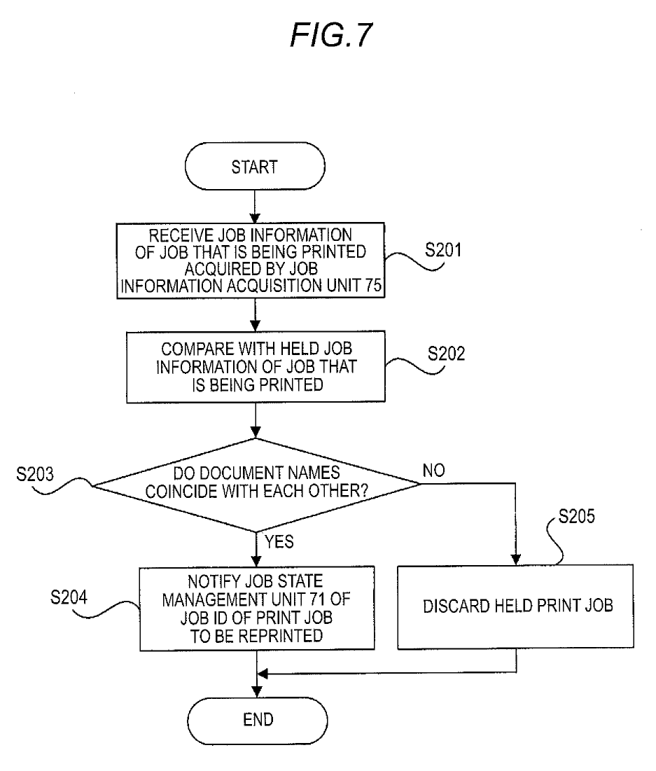

The operation of the output management unit 72 when the print processing is restarted will be described with reference to a flowchart in FIG. 7.

First, when the job information on the job that is being printed acquired by the job information acquisition unit 75 is received from the output device 50 and the job information of the print job is received from the print server 41 in the active system (STEP S201), the output management unit 72 compares the received job information with the held information on the job that is being printed (STEP S202).

Then, in a case where the document name information included in the compared job information coincides with that in the held information (Yes in STEP S203), the output management unit 72 notifies the job state management unit 71 of the job ID of the print job to be reprinted, and performs the reprinting (STEP S204).

At this time, the output management unit 72 compares the output page information included in the job information on the job that is being printed acquired by the job information acquisition unit 75 from the output device 50 and the output page information included in the job information on the print job from the print server 41 in the active system, and then, determines the reprinting start page or the number of check pages.

In a case where the document names do not coincide with each other in STEP S203, the output management unit 72 discards the held print job (STEP S205).

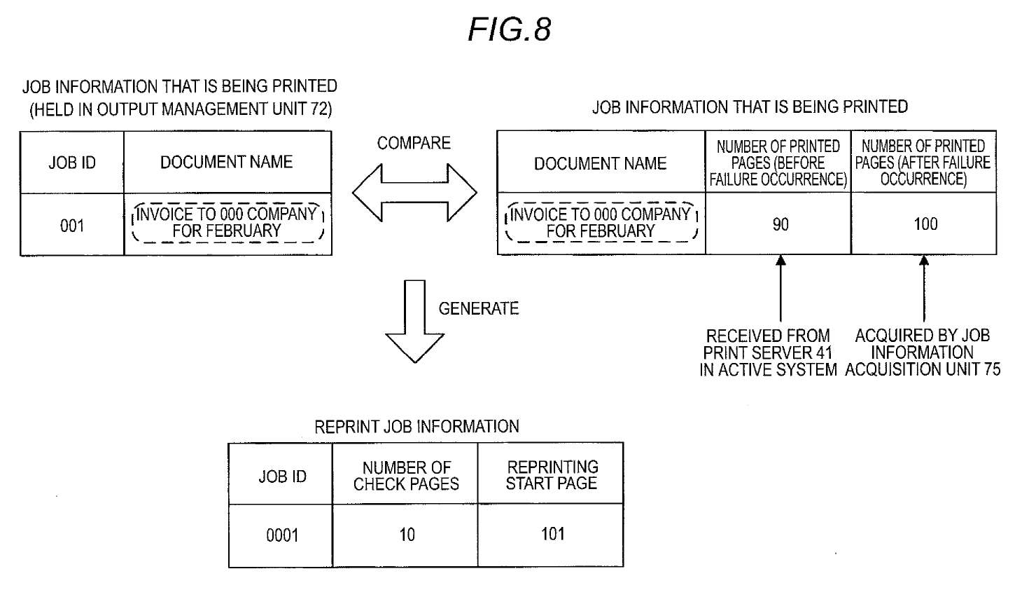

A specific example of generating the print job information for the output management unit 72 to perform the reprinting as described above will be described with reference to FIG. 8.

In FIG. 8, the description will be made under the assumption that the number of output pages of which the printing is normally finished acquired by the job information acquisition unit 75 is 100, and the number of output pages received from the print server 41 in the active system is 90.

That is, despite that, in the print server 41 in the active system, the number of output pages checked before the occurrence of failure is 90, but actually the print processing is normally finished up to page 100 by the output device 50.

In such a case, the output management unit 72 determines the reprinting start page as page 101 based on the number of output pages of 100 pages acquired by the job information acquisition unit 75 with reference to those two numbers of output pages.

However, since the number of output pages that can be checked by the print server 41 in the active system before the occurrence of failure is 90, the 10 pages (page 91 to page 100) which is the difference between the above-described 90 pages and the number of output pages of 100 pages acquired by the job information acquisition unit 75 is set as a check page which is required to be visually checked by the user.

In addition, the job ID of the print job to perform the reprinting is specified as “0060” by the fact that the combination of the information items of the job ID “0061” held in the output management unit 72 as the information on the job that is being printed and the document name “Invoice to 000 Company for February”, and the document name “Invoice to 000 Company for February” in the job information that is being printed acquired from the job information acquisition unit 75, are coincident with each other.

In this way, the output management unit 72 causes the reprinting to be started by notifying the job state management unit 71 which generates the reprint job information in which the job ID is “0063”, the number of check pages is “10”, and the reprinting start page is the page “101” to start the reprinting.

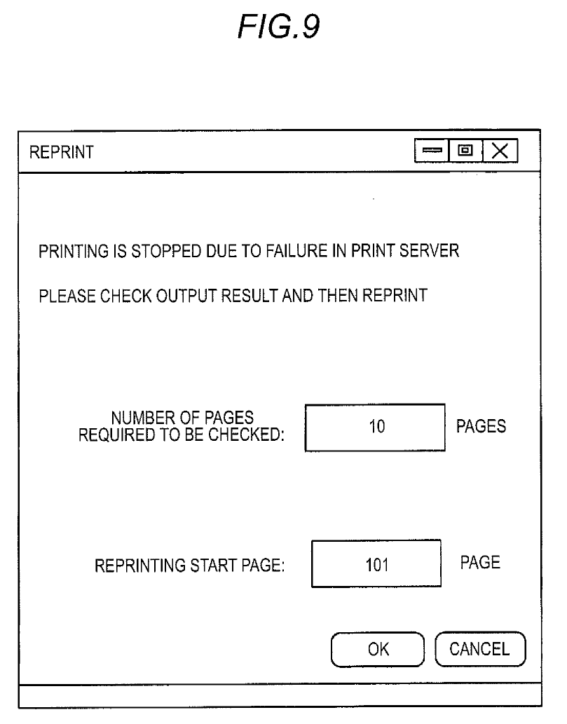

In the job state management unit 71, the reprint job notified from the output management unit 72 may be started to reprint only in a case where a display screen illustrated in, for example, FIG. 9 is displayed on the UI unit 76 and the user checks and permits the performing of the starting of the reprinting, without performing the reprint job notified from the output management unit 72 as it is.

To the user, the display screen illustrated in FIG. 9 indicates that the reprinting is started from the 101st page, and it is required to check whether or not the 10 pages from page 91 to page 100 are normally printed.

In a case the user has an intention to start the reprinting as it is, the user may operate an OK button. In a case where the user performs a visual checking of the output result of the output device 50 and has an intention to start the reprinting from another page, the reprinting can be performed from another page by modifying the reprinting start page via the UI unit 76.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A print control device comprising:
a storage unit that stores print data which is being processed in another print control device that controls a printing device so as to perform print processing based on received the print data;
an acquisition unit that acquires second printed-page information from the printing device; and
a controller, wherein
when an error occurs in the other print control device, the controller receives first printed-page information from the other print control device, determines a restart page from the first printed-page information received from the other print control device and the second printed-page information acquired by the acquisition unit, and controls the printing device on behalf of the other print control device so as to restart the print processing based on the print data from the restart page.

2. The print control device according to claim 1,
wherein when the error occurs in the other print control device, the controller determines a page next to a page indicated by the second printed-page information as the restart page.

3. The print control device according to claim 1,
wherein when the first printed-page information and the second printed-page information are different from each other, the controller displays pages between the page indicated by the first printed-page information and a page indicated by the second printed-page information so as to be checked.

4. The print control device according to claim 1, further comprising:
a receiving unit that receives a copy of the print data that is being printed, from the other print control device via a communication line.

5. The print control device according to claim 1,
wherein the acquisition unit acquires name information of the print data from the printing device together with the second printed-page information, and
wherein the controller determines print data to reprint by the name information from among the print data stored in the storage unit.

6. A printing system comprising:
a first print control device that controls a printing device so as to perform print processing based on received print data; and
a second print control device that includes
a storage unit that stores the print data which is being processed in the first print control device;
an acquisition unit that acquires second printed-page information from the printing device; and
a controller, wherein
when an error occurs in the first print control device, the controller receives first printed-page information from the first print control device, determines a restart page from the first printed-page information received from the first print control device and the second printed-page information acquired by the acquisition unit, and controls the printing device on behalf of the first print control device so as to restart the print processing based on the print data from the restart page.

7. A non-transitory computer readable medium storing a program that causes a computer to execute print control processing comprising:
storing print data which is being processed in another print control device that controls a printing device so as to perform print processing based on received the print data;
acquiring second printed-page information from the printing device; and
when an error occurs in the other print control device,
receiving first printed-page information from the other print control device,
determining a restart page from the first printed-page information received from the other print control device and the second printed-page information, and
controlling the printing device on behalf of the other print control device so as to restart the print processing based on the print data from the restart page.
